(19) United States
(12) Patent Application Publication
(10) Pub. No.: US 2019/0295131 A1
(43) Pub. Date: Sep. 26, 2019

(54) ADVERTISEMENT PLACEMENT METHOD, PLUG-IN, BROWSER, COMPUTING DEVICE, AND STORAGE MEDIUM

(71) Applicant: ALIBABA GROUP HOLDING LIMITED, Grand Cayman (KY)

(72) Inventor: Binghui ZHANG, HANGZHOU (CN)

(21) Appl. No.: 16/441,862

(22) Filed: Jun. 14, 2019

Related U.S. Application Data
(63) Continuation of application No. PCT/CN2017/113997, filed on Nov. 30, 2017.

(30) Foreign Application Priority Data
Dec. 16, 2016 (CN) 201611167838.5

(51) Int. Cl. G06Q 30/02; G06F 17/21

(52) U.S. Cl. CPC G06Q 30/0269; G06Q 30/0277; G06F 17/212

(57) ABSTRACT

The disclosure provides an ad serving method, plugin, browser, computer device and storage medium. The method comprises obtaining, through a browser, a page on which an ad is to be served, providing a serving configuration interface for serving the ad on the page, receiving a configuration result through the serving configuration interface and determining, based on the configuration result, ad display parameters for serving the ad on the page, and determining the page with the ad to be served based on the ad display parameters.

### CROSS-REFERENCE TO RELATED APPLICATIONS

The present application is a continuation application of International Patent Application No. PCT/CN2017/113997, filed on Nov. 30, 2017, which is based on and claims priority to the Chinese Patent Application No. 201611167838.5, filed on Dec. 16, 2016 and entitled “Advertisement Placement Method, Plug-in, Browser, Computing Device, and Storage Medium.” The above-referenced applications are incorporated herein by reference in their entirety.

### TECHNICAL FIELD

The application relates to the field of computer technologies, and in particular, to a method, a plugin, and a browser for advertising (also referred to as advertisement serving hereinafter).

### BACKGROUND

With the rise of the Internet, online advertising has become the primary profit method used by each large web portal, search engine, social network, and terminal communication equipment application. Currently, the Internet advertising market is growing at an astonishing rate, and the effectiveness demonstrated by the Internet advertising becomes increasingly significant. Because an advertising display mode is the most important influencing factor for advertising profits, advertisers and advertisement (ad) display providers both expect to serve advertisements (ads) through the most advantageous display mode.

In current technologies, on the one hand, the display modes used for serving ads are generally to embed the ad into the advertising (also referred to as “ad serving”) page in an iframe (HTML tags) format, and thus display styles for serving the ads are usually unvarying; most ads can only be served on a relatively separate and fixed position on the ad serving page, causing ad display results on the ad serving page to appear very stark. On the other hand, customization of the ads is usually accomplished through a fixed template, and thus appearance styles of the ads are rather unvarying. In addition, sometimes a fixed template is not able to match an ad with a serving page, and therefore the resulting ad serving page may have an unsatisfactory aesthetic appearance. Accordingly, advertisers and ad display providers both expect that ads can be customized to meet actual needs and to have more attractive display styles on the ad serving pages, thereby increasing click-through rates of the ads.

### SUMMARY

In order to overcome or at least partially resolve the above-described technical issues, the following technical schemes are provided.

Embodiments of the specification provide a method for ad serving, comprising obtaining, through a browser of a predetermined type and with a loaded ad serving plugin, a page on which an ad is to be served, providing a serving configuration interface for serving the ad on the page, receiving a configuration result through the serving configuration interface and determining ad display parameters for serving the ad on the page based on the configuration result, and determining the page with the ad to be served based on the ad display parameters.

Optionally, the method further comprises: loading the ad serving plugin in the browser of the predetermined type, and performing an initial configuration of the ad serving plugin to provide the serving configuration interface.

In some embodiments, the ad display parameters comprise at least one of the following: an ad location; an ad serving window style; an ad display color; an ad serving window size; and an ad serving style.

In some embodiments, when ad display parameters include ad location, receiving a configuration result for the serving configuration interface and determining ad display parameters for serving the ad on the page based on the configuration result comprises: receiving a selection result of at least one adjacent element for serving the ad on the page, and determining a position relationship of the ad to be served and the at least one adjacent element based on the selection result.

Optionally, the method further comprises: providing a selection interface for displaying a preview result of serving the ad on the page, and when receiving a preview instruction through the selection interface, displaying a preview of the page on which the ad is served.

Optionally, the method further comprises: generating a serving configuration file based on the ad display parameters and the ad to be served, and sending the serving configuration file to a server for the server to serve the ad.

Optionally, the method further comprises: obtaining, by the server, the ad display parameters and the ad to be served from the serving configuration file, and serving the ad on the page based on the ad display parameters; or receiving, by a client, the page on which the ad is to be served and the serving configuration file from the server, obtaining the ad display parameters and the ad from the serving configuration file, and serving the ad on the page based on the ad di splay parameters.

Embodiments of the specification further provide a plugin for ad serving, comprising an obtaining and providing module configured to obtain a page on which an ad is to be served, and provide a serving configuration interface for serving the ad on the page, a receiving and determining module configured to receive a configuration result through the serving configuration interface and determine ad display parameters for serving the ad on the page based on the configuration result, and a determining module configured to determine the page with the ad to be served based on the ad display parameters.

The ad display parameters may comprise at least one of the following an ad location; an ad serving window style; an ad display color; an ad serving window size; and an ad serving style. In some embodiments, the ad display parameters include the ad serving location, and the receiving and determining module comprises a receiving unit configured to receive a selection result of at least one adjacent element for serving the ad on the page, and a determining unit configured to determine a position relationship of the ad and the at least one adjacent element based on the selection result.

Optionally, the plugin further comprises a providing module configured to provide a selection interface for displaying a preview result of serving the ad on the page, and a preview module configured to display a preview of the page on which the ad is served when receiving a preview instruction through the selection interface.

Optionally, the plugin further comprises a sending module configured to generate a serving configuration file based on the ad display parameters and the ad, and send the serving configuration file to a server for the server to serve the ad.

Yet another embodiment of the specification provides a browser for ad serving, comprising the above-described plugin for ad serving.

The specification further provides a computing device, comprising: a processor; and a memory storing executable code that, when executed by the processor, causes the processor to perform any one of the methods for ad serving as described above.

The specification further provides a non-transitory machine readable storage medium storing executable code that, when executed by a computing device processor, causes the processor to perform any one of the methods for ad serving as described above.

In the embodiments of the specification, ad serving schemes are provided. An ad serving page on which an ad is to be served can be obtained through a browser of a predetermined type and including a loaded ad serving plugin. A serving configuration interface for serving the ad on the page can be provided to achieve an ad customization configuration. In addition, the ad serving plugin has a capability to access page elements, and by selecting elements on the ad serving page, the ad serving plugin can flexibly determine a display position of the ad on the ad serving page. Further, display configuration information of the corresponding elements on the ad serving page and the ad serving website can be obtained to customize display configuration parameters for serving the ad and to enable a more robust serving as well as customization of the ad. A configuration result can be received through the serving configuration interface, and ad display parameters can be determined for serving the ad on the ad serving page. The page including the served ad can be determined based on the ad display parameters, enabling the display mode of the ad on the ad serving page to be flexibly configured based on the ad customization parameters, and thereby avoiding limitations and monotonousness in customizing the ad based on a fixed template. Moreover, while ad customization efficiency can be increased and ad customization costs can be largely saved, the ads can be presented in a more attractive style on the ad serving page. Furthermore, the ad click-through rate on the ad operating platform and corresponding profits can be increased.

Additional aspects and advantages of the application will be described below, and will become more clear and be understood through embodiments of the application.

### BRIEF DESCRIPTION OF THE DRAWINGS

The above-mentioned and/or additional aspects and advantages of the application will be more clear and easily understood based on the description of the embodiments in conjunction with the accompanying drawings, where:

FIG. 1 is a flow chart of an ad serving method according to some embodiments of the application;

FIG. 2 is a structural schematic diagram of an ad serving plugin according to some embodiments of the application.

### DETAILED DESCRIPTION

The embodiments of the disclosure will be described in detail below, and the embodiments and examples are shown in the accompanying drawings, where the same or similar numerals indicate the same or similar elements or elements with the same or similar functions. The embodiments described below by referencing the accompanying drawings are examples, and are only used for explaining the disclosure and cannot be interpreted as limitations to the disclosure.

Those skilled in the art can appreciate that, unless stated otherwise, the singular forms “a,” “one,” “said” and “this” used hereinafter can also include plural forms. It should be further understood that the phrase “comprising” used in the description of the disclosure refer to the existence of the characteristic, whole number, step, operation, element and/or component, but do not exclude the existence of or addition of one or more other characteristics, whole numbers, steps, operations, elements and/or their components. It should be understood that, when an element is “connected” or “coupled” to another element, the element can be directly connected or coupled to the other element, or there can also be an intermediate element. In addition, “connected” or “coupled” used hereinafter can include a wireless connection or wireless coupling. The phrase “and/or” used hereinafter includes all or any one unit and all combinations of one or more associated listed items.

Those skilled in the art can understand that, unless otherwise defined, all terms used hereinafter (including technical terminologies and scientific terminologies) have the same respective meanings to those of ordinary skills in the art of the disclosure. It should also be understood that those terms defined in a general dictionary should be understood as having meanings identical to the meanings in the current technical context; in addition, unless specifically defined, the terms will not be interpreted to have idealized or excessively formal meanings.

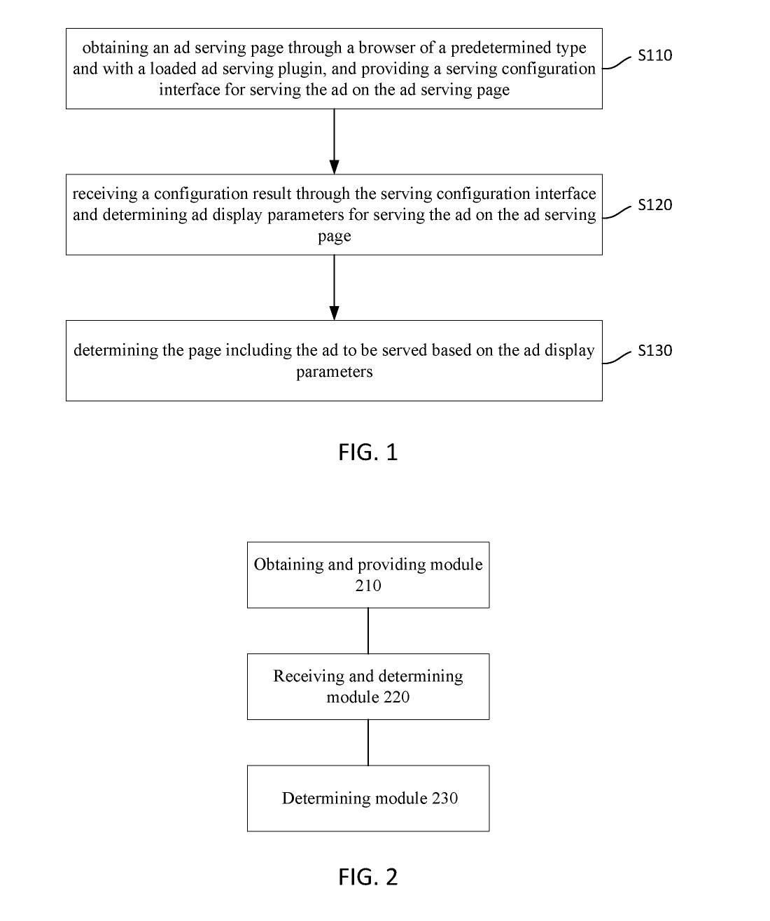

FIG. 1 is a flow chart of an ad serving method according to some embodiments in the disclosure. The content executed at each step is as follows: at Step S110, obtaining an ad serving page through a browser of a predetermined type and including a loaded ad serving plugin, and providing a serving configuration interface for serving the ad on the ad serving page; at Step S120, receiving a configuration result through the serving configuration interface and determining ad display parameters for serving the ad on the ad serving page; and at Step S130, determining the page including the ad to be served based on the ad display parameters.

In some embodiments, ad serving schemes are provided. An ad serving page on which an ad is to be served can be obtained through a browser of a predetermined type and including a loaded ad serving plugin. A serving configuration interface for serving the ad on the page can be provided to achieve an ad customization configuration. In addition, the ad serving plugin has a capability to access page elements, and by selecting elements on the ad serving page, the ad serving plugin can flexibly determine a display position of the ad on the ad serving page. Further, display configuration information of the corresponding elements on the ad serving page and the ad serving website can be obtained to customize display configuration parameters for serving the ad and to enable a more robust serving as well as customization of the ad. A configuration result can be received through the serving configuration interface, and ad display parameters can be determined for serving the ad on the ad serving page. The page including the served ad can be determined based on the ad display parameters, enabling the display mode of the ad on the ad serving page to be flexibly configured based on the ad customization parameters, and thereby avoiding limitations and monotonousness in customizing the ad based on a fixed template. Moreover, while ad customization efficiency can be increased and ad customization costs can be largely saved, the ads can be presented in a more attractive style on the ad serving page. Furthermore, the ad click-through rate on the ad operating platform and corresponding profits can be increased.

At Step S110: obtaining an ad serving page through a browser of a predetermined type and including a loaded ad serving plugin, and providing a serving configuration interface for serving the ad on the ad serving page.

In some embodiments, an ad serving page can be obtained through a browser of a predetermined type and including a loaded ad serving plugin. The ad serving plugin can provide a serving configuration interface for serving the ad on an ad serving page.

For example, through a browser of a predetermined type and including a loaded ad serving plugin “ADPlugin,” such as the Chrome browser (Google browser) or Baidu browser, an advertiser A may select an ad serving page on which an ad is to be served, such as index.html. After the ADPlugin obtains the ad serving page, index.html, the ADPlugin may provide a serving configuration interface for serving the ad on the ad serving page for the advertiser A to configure information such as a display style, a display color and a display position for serving the ad on the index.html page. For example, the serving configuration interface includes options for each serving configuration parameter and parameter import windows. For example, the serving configuration interface may be included in a configuration page related to serving the ad, and uses color configuration information (such as red) in the index.html page obtained by the ADPlugin to provide the user (such as the advertiser A) with a configuration option of “red” as the display color of the ad. Further, a tone tray including multiple display colors can also be provided for the user to select a corresponding color in the tone tray for displaying the ad on the ad serving page. Alternatively, the user can be enabled to select the ad's display color on the ad serving page by inputting a corresponding RGB color value in each RGB color value box provided in the serving configuration interface such as an interactive interface.

In some embodiments, after installing the ad serving plugin, the browser can invoke the plugin. For example, the browser can provide a loading manner such that the plugin can be loaded onto an application and a network transmission protocol, enabling data exchange between the browser and the plugin.

In some embodiments, before Step S110, the method may further include Step S140. At Step S140: loading an ad serving plugin in the browser of the predetermined type and performing an initial configuration of the ad serving plugin to provide an serving configuration interface. For example, the browser of the predetermine type such as the Chrome browser may allow the advertiser A to log onto an ad platform “ADplatform.” After the advertiser A logs on, if the ad platform detects that an ad serving plugin “ADPlugin” has not been loaded on the Chrome browser, the ad platform may allow the user (such as the advertiser A) to actively trigger or automatically execute an selection in a plugin loading setup and load the ad serving plugin ADPlugin on the Chrome browser. Further, the ad platform may also perform an initial configuration of the ADPlugin, for example, based on configuration information in a plugin configuration file such as “manifest.json.” The configuration may include configuring the plugin name as ADPlugin, the plugin description information as direct ad delivery, and the plugin display page as devtools.html, etc., in order to provide a serving configuration interface in the following step. Moreover, the usage privileges and version information can also be configured. In some embodiments, after the advertiser A opens the Chrome developer tool page in the Chrome browser, the serving configuration interface provided by the ADPlugin may enable the advertiser A to configure the ad on the index.html page correspondingly.

In some embodiments, the Chrome developer tools are a collection of Web development and debugging tools built into the Chrome browser, and the developer tools allow Web developers to thoroughly understand the internal structures of the browser itself and the applications. The developer tools allows the developers to effectively check a page layout, set up JavaScript break points, and obtain code optimization recommendations. In some embodiments, Chrome plugins are browser plugins for expanding capabilities of the Google Chrome browser. These plugins are usually developed by using HTML, JavaScript and CSS technologies. The ad serving plugin among the Chrome plugins in the embodiments of the disclosure has basic functions of an ad serving platform, such as management of ad slots, which includes adding a new ad slot, removing an ad slot and modifying an ad slot, as well as ad serving page management, which includes adding a new ad serving page, removing an ad serving page and modifying an ad serving page. For example, the ad serving plugin can be developed based on vue.js to achieve the basic functions of an ad serving platform.

At Step S120: receiving a configuration result through the serving configuration interface and determining ad display parameters for serving the ad on the ad serving page.

In some embodiments, the ad display parameters may include at least one of the following:

1) an ad serving position; for example, the display position of the ad on the ad serving page, including identification information of a front element or rear element next to the ad's display window on the ad serving page.

2) an ad serving window style; for example, a floating type, an embedding type, a sliding type, etc.

3) ad display tones; for example, ad display color information.

4) ad serving window dimensions; for example, ad serving window size information.

5) an ad serving style. For example, the ad serving style can include a style of the background image of the ad serving window, such as a simple yet elegant background image, a festive background image, etc.

In some embodiments, the web page ad style can include text link ad, banner ad, rich media ad, video ad, interstitial ad and search engine bidding ad, etc. The banner ads can be static, moving, and interactive. Therefore, different ad display parameters can be configured based on different requirements.

For example, the advertiser A logs onto ad platform “ADplatform” in the predetermined Chrome browser, selects an ad serving page as index.html. After an ad serving plugin ADPlugin obtains the ad serving page, index.html, the ADPlugin can obtain display configuration information, such as page color information, layout information, etc., of the index.html page and the website where the page is located, such as “http://www.aaa.com/”. In addition, the ADPlugin may use an interactive interface to provide the advertiser A with an serving configuration interface for serving the ad on the ad serving page index.html. For example, display-related configuration options or text boxes are provided in the serving configuration interface for the user to make selections. The advertiser A inputs or selects corresponding configuration results through the serving configuration interface, and the configuration results include the ad display parameters that the advertiser A has entered, such as an ad window size ratio set up by the advertiser A according to the layout configuration of the index.html page, a color tone of the ad according to the color configuration of the index.html page, a serving style of the ad according to the website style configuration of the index.html page, and self-defined style information of ad-related elements.

In some embodiments, when the ad display parameters include an ad serving position, Step S120 further includes Step S121 and Step S122; Step S121: receiving the selection result of at least one adjacent element for serving the ad on the ad serving page; Step S122: determining a position relationship of the ad to be served and the at least one adjacent element based on the selection result.

For example, further to the example above, when the ad display parameters for serving the ad on the ad serving page include the ad position, the ADPlugin receives a choice result of at least one adjacent element for serving the ad on the ad serving page index.html, for example, selecting the identification information of one adjacent element as name=“message”, and selecting a positional relationship of the ad and its adjacent element, such as a selection result of “insertBefore” if the ad position is to be in front of the adjacent element, and a selection result of “insertAfter” if the ad position is to be behind the adjacent element, and a selection result of “replace” if the ad is to replace the adjacent element, etc. The ADPlugin may also configure XML path language (XPath) information of the element having the obtained identification information name=“message” into XPath information of the ad position on the ad serving page, and determine the positional relationship of the ad and the element having the identification information name=“message” as, for example, the ad being in front of the adjacent element. Thus, the positional relationship of the ad and the element having the identification information name=“message” can be determined.

In some embodiments, HyperText Markup Language (HTML) page elements refer to all code from the start tag to the end tag, and many browser elements and properties can be added into the HTML. For example, the HTML defines content of various data-type elements, such as script data and style sheet data, as well as many types of property values including ID, name, URL, numerals, length unit, language, media descriptors, color, character encoding, data and time, etc. All of these data types are specialized character data. In some embodiments, XPath refers to XML Path Language (extensible markup language path language), and is a type of language used to determine a position of a part in the XML file. For example, in order to precisely find a node element when matching the XML file's structure tree, “copy xpath” can be selected through the developer tools to obtain an Xpath address of the element. This can be applied to an HTML tag page. Alternatively, a tag node's position in the HTML page may be uniquely labeled through a tag node hierarchical relationship/attribute/relative position order, such that the related elements can be located. For example, the XPath description information describing a tag node “a” in a html page is “/html/body/div[1]/div[4]/div[5]/center/a[3]”.

In some embodiments, native advertising customization can also be performed in the developer tools. For example, elements that need customization can be selected in the Elements options card and style or structure adjustments of the selected element can be performed.

At Step S130: determining the page with the ad to be served based on the ad display parameters. In this step, how to construct the page with the ad to be served can be determined. For example, values of corresponding parameters of the ad serving page can be determined or set based on the values of the ad display parameters. For example, the color of the ad display window in the ad serving page can be set as blue in response to the value of the ad display window color parameter being blue, thereby determining the page with the ad to be served. This way, the ad has a corresponding display on the ad serving page index.html based on values of such received parameters as configuration display color, display style, display size, display mode, etc.

In some embodiments, this method may further comprise Step S150 and Step S160; at Step S150: providing a selection interface for displaying preview results of the ad in the ad serving page; at Step S160: when receiving preview instructions through the selection interface, displaying a preview of the page with the served ad.

For example, the ad serving plugin ADPlugin provides a selection interface for displaying preview results of the ad in the ad serving page. For example, the ADPlugin provides a preview button in an interactive interface, and when the advertiser A clicks the preview button, the ADPlugin can receive a preview command sent by the advertiser A through the selection interface, then render the page including the served ad based on the corresponding configuration information of the page, render the ad display results and display a preview of the page.

As another example, the ad serving plugin ADPlugin provides a selection interface for displaying the preview results of the ad on the ad serving page. When the advertiser A stores ad configuration code to a predetermined directory of the ADPlugin through the interactive interface of the ad serving platform ADplatform in the Chrome browser, and revises the configuration information in the configuration file manifest.json, such as adding a content scripts configuration section, etc., and then, after the advertiser A executes a refresh operation on the page with the served ad, a preview command is received, the page with the served ad is rendered based on the corresponding configuration information of the page, the ad display results is also rendered and a preview of the page is displayed.

Through the embodiments, the shortcoming in the current technologies of being unable to examine ad customization results in real time has been overcome, a real-time examination of an ad's serving results after completing ad customization has been realized, and the steps for examining the ad serving results have been simplified. In addition, based on examination of the serving results, corresponding adjustments can be promptly performed for the customized ad, greatly increasing ad customization capability.

In some embodiments, this method may further comprise Step S170; at Step S170: generating a serving configuration file based on the ad display parameters and the ad to be served; and sending the serving configuration file to a server for the server to serve the ad on the page.

For example, the serving configuration file for the ad is generated based on the ad display parameters and the ad, and the serving configuration file is sent to the server through the ad platform ADplatform in the Chrome browser for the server to serve the ad; after the server has completed serving the ad, each client user can check the ad as displayed according to the corresponding configuration parameters by visiting the address of the ad page, such as “http://www.aaa.com/index.html”.

In some embodiments, the server obtains the ad display parameters and the ad from the serving configuration file, and serves the ad on an ad page based on the ad display parameters. In other embodiments, a client receives the ad serving page and the serving configuration file from the server, obtains the ad display parameters and the ad from the serving configuration file, and inserts the ad in the ad serving page based on the ad display parameters.

FIG. 2 is a structural schematic diagram of an ad serving plugin according to some embodiments of the disclosure. In the embodiments of the disclosure, the ad serving plugin may include: an obtaining and providing module 210 configured to obtain an ad serving page through a browser of a predetermined type and including a loaded ad serving plugin, and provide a serving configuration interface for serving the ad on the ad serving page; a receiving and determining module 220 configured to receive a configuration result through the serving configuration interface and determine ad display parameters for serving the ad on the ad serving page; a determining module 230 configured to determine the page including the served ad based on the ad display parameters.

In some embodiments, an ad serving plugin is provided to obtain an ad serving page. A serving configuration interface for serving the ad on the page can be provided to achieve an ad customization configuration. In addition, the ad serving plugin has a capability to access page elements, and by selecting elements on the ad serving page, the ad serving plugin can flexibly determine a display position of the ad on the ad serving page. Further, display configuration information of the corresponding elements on the ad serving page and the ad serving website can be obtained to customize display configuration parameters for serving the ad and to enable a more robust serving as well as customization of the ad. A configuration result can be received through the serving configuration interface, and ad display parameters can be determined for serving the ad on the ad serving page. The page including the served ad can be determined based on the ad display parameters, enabling the display mode of the ad on the ad serving page to be flexibly configured based on the ad customization parameters, and thereby avoiding limitations and monotonousness in customizing the ad based on a fixed template. Moreover, while ad customization efficiency can be increased and ad customization costs can be largely saved, the ads can be presented in a more attractive style on the ad serving page. Furthermore, the ad click-through rate on the ad operating platform and corresponding profits can be increased.

The obtaining and providing module 210 is configured to obtain an ad serving page through a browser of a predetermined type and including a loaded ad serving plugin, and provide a serving configuration interface for serving the ad on the ad serving page.

For example, through a browser of a predetermined type and including a loaded ad serving plugin “ADPlugin,” such as the Chrome browser (Google browser) or Baidu browser, an advertiser A may select an ad serving page on which an ad is to be served, such as index.html. After the ADPlugin obtains the ad serving page, index.html, the ADPlugin may provide a serving configuration interface for serving the ad on the ad serving page for the advertiser A to configure information such as a display style, a display color and a display position for serving the ad on the index.html page. For example, the serving configuration interface includes options for each serving configuration parameter and parameter import windows. For example, the serving configuration interface may be included in a configuration page related to serving the ad, and uses color configuration information (such as red) in the index.html page obtained by the ADPlugin to provide the user (such as the advertiser A) with a configuration option of “red” as the display color of the ad. Further, a tone tray including multiple display colors can also be provided for the user to select a corresponding color in the tone tray for displaying the ad on the ad serving page.

In another example, the browser of the predetermine type such as the Chrome browser may allow the advertiser A to log onto an ad platform “ADplatform.” After the advertiser A logs on, if the ad platform detects that an ad serving plugin “ADPlugin” has not been loaded on the Chrome browser, the ad platform may allow the user (such as the advertiser A) to actively trigger or automatically execute an selection in a plugin loading setup and load the ad serving plugin ADPlugin on the Chrome browser. Further, the ad platform may also perform an initial configuration of the ADPlugin, for example, based on configuration information in a plugin configuration file such as “manifest.json.” The configuration may include configuring the plugin name as ADPlugin, the plugin description information as direct ad delivery, and the plugin display page as devtools.html, etc., in order to provide a serving configuration interface in the following step. Moreover, the usage privileges and version information can also be configured. In some embodiments, after the advertiser A opens the Chrome developer tool page in the Chrome browser, the serving configuration interface provided by the ADPlugin may enable the advertiser A to configure the ad on the index.html page correspondingly.

In some embodiments, the Chrome developer tools are a collection of Web development and debugging tools built into the Chrome browser, and the developer tools allow Web developers to thoroughly understand the internal structures of the browser itself and the applications. The developer tools allows the developers to effectively check a page layout, set up JavaScript break points, and obtain code optimization recommendations. In some embodiments, Chrome plugins are browser plugins for expanding capabilities of the Google Chrome browser. These plugins are usually developed by using HTML, JavaScript and CSS technologies. The ad serving plugin among the Chrome plugins in the embodiments of the disclosure has basic functions of an ad serving platform, such as management of ad slots, which includes adding a new ad slot, removing an ad slot and modifying an ad slot, as well as ad serving page management, which includes adding a new ad serving page, removing an ad serving page and modifying an ad serving page. For example, the ad serving plugin can be developed based on vue.js to achieve the basic functions of an ad serving platform.

The receiving and determining module 220 is configured to receive a configuration result through the serving configuration interface and determine ad display parameters for serving the ad on the ad serving page.

In some embodiments, the ad display parameters may include at least one of the following:

1) an ad serving position; for example, the display position of the ad on the ad serving page, including identification information of a front element or rear element next to the ad's display window on the ad serving page.

2) an ad serving window style; for example, a floating type, an embedding type, a sliding type, etc.

3) ad display tones; for example, ad display color information.

4) ad serving window dimensions; for example, ad serving window size information.

5) an ad serving style. For example, the ad serving style can include a style of the background image of the ad serving window, such as a simple yet elegant background image, a festive background image, etc.

For example, the advertiser A logs onto ad platform “ADplatform” in the predetermined Chrome browser, selects an ad serving page as index.html. After an ad serving plugin ADPlugin obtains the ad serving page, index.html, the ADPlugin can obtain display configuration information, such as page color information, layout information, etc., of the index.html page and the website where the page is located, such as “http://www.aaa.com/”. In addition, the ADPlugin may use an interactive interface to provide the advertiser A with an serving configuration interface for serving the ad on the ad serving page index.html. For example, display-related configuration options or text boxes are provided in the serving configuration interface for the user to make selections. The advertiser A inputs or selects corresponding configuration results through the serving configuration interface, and the configuration results include the ad display parameters that the advertiser A has entered, such as an ad window size ratio set up by the advertiser A according to the layout configuration of the index.html page, a color tone of the ad according to the color configuration of the index.html page, a serving style of the ad according to the website style configuration of the index.html page, and self-defined style information of ad-related elements.

In some embodiments, when the ad display parameters include an ad serving position, the receiving and determining module 220 further includes a receiving unit and a determining unit; the receiving unit is configured to receives the selection result of at least one adjacent element for serving the ad on the ad serving page; and the determining unit is configured to determine a position relationship of the ad to be served and the at least one adjacent element based on the selection result.

For example, further to the example above, when the ad display parameters for serving the ad on the ad serving page include the ad position, the ADPlugin receives a choice result of at least one adjacent element for serving the ad on the ad serving page index.html, for example, selecting the identification information of one adjacent element as name=“message”, and selecting a positional relationship of the ad and its adjacent element, such as a selection result of “insertBefore” if the ad position is to be in front of the adjacent element, and a selection result of “insertAfter” if the ad position is to be behind the adjacent element, and a selection result of “replace” if the ad is to replace the adjacent element, etc. The ADPlugin may also configure XML path language (XPath) information of the element having the obtained identification information name=“message” into XPath information of the ad position on the ad serving page, and determine the positional relationship of the ad and the element having the identification information name=“message” as, for example, the ad being in front of the adjacent element. Thus, the positional relationship of the ad and the element having the identification information name=“message” can be determined.

In some embodiments, HyperText Markup Language (HTML) page elements refer to all code from the start tag to the end tag, and many browser elements and properties can be added into the HTML. For example, the HTML defines content of various data-type elements, such as script data and style sheet data, as well as many types of property values including ID, name, URL, numerals, length unit, language, media descriptors, color, character encoding, data and time, etc. All of these data types are specialized character data. In some embodiments, XPath refers to XML Path Language (extensible markup language path language), and is a type of language used to determine a position of a part in the XML file. For example, in order to precisely find a node element when matching the XML file's structure tree, “copy xpath” can be selected through the developer tools to obtain an Xpath address of the element. This can be applied to an HTML tag page. Alternatively, a tag node's position in the HTML page may be uniquely labeled through a tag node hierarchical relationship/attribute/relative position order, such that the related elements can be located. For example, the XPath description information describing a tag node “a” in a html page is “/html/body/div[1]/div[4]/div[5]/center/a[3]”.

In some embodiments, native advertising customization can also be performed in the developer tools. For example, elements that need customization can be selected in the Elements options card and style or structure adjustments of the selected element can be performed.

The determining module 230 is configured to determine the page with the served ad based on the ad display parameters. For example, values of corresponding parameters of the ad serving page can be set based on the values of the ad display parameters. For example, the color of the ad display window in the ad serving page can be set as blue in response to the value of the ad display window color parameter being blue, thereby determining the page with the served ad. This way, the ad has a corresponding display on the ad serving page index.html based on values of such received parameters as configuration display color, display style, display size, display mode, etc.

In some embodiments, the ad serving plugin may further include a providing module and a preview module; the providing module is configured to provide a selection interface for displaying preview results of the ad in the ad serving page; and the preview module is configured to display a preview of the page with the served ad when receiving preview instructions through the selection interface.

For example, the ad serving plugin ADPlugin provides a selection interface for displaying preview results of the ad in the ad serving page. For example, the ADPlugin provides a preview button in an interactive interface, and when the advertiser A clicks the preview button, the ADPlugin can receive a preview command sent by the advertiser A through the selection interface, then render the page including the served ad based on the corresponding configuration information of the page, render the ad display results and display a preview of the page.

As another example, the ad serving plugin ADPlugin provides a selection interface for displaying the preview results of the ad on the ad serving page. When the advertiser A stores ad configuration code to a predetermined directory of the ADPlugin through the interactive interface of the ad serving platform ADplatform in the Chrome browser, and revises the configuration information in the configuration file manifest.json, such as adding a content scripts configuration section, etc., and then, after the advertiser A executes a refresh operation on the page with the served ad, a preview command is received, the page with the served ad is rendered based on the corresponding configuration information of the page, the ad display results is also rendered and a preview of the page is displayed.

Through the embodiments, the shortcoming in the current technology of being unable to examine ad customization results in real time has been overcome, and a real-time examination of an ad's serving results after completing ad customization has been realized, and the steps for examining the ad serving results have been simplified. In addition, based on examination of the serving results, corresponding adjustments can be promptly performed for the customized ad, greatly increasing ad customization capability.

In some embodiments, the ad serving plugin may further include a sending module, configured to generate a serving configuration file based on the ad display parameters and the ad to be served and send the serving configuration file to a server for the server to serve the ad on the page.

For example, the serving configuration file for the ad is generated based on the ad display parameters and the ad, and the serving configuration file is sent to the server through the ad platform ADplatform in the Chrome browser for the server to serve the ad; after the server has completed serving the ad, each client user can check the ad as displayed according to the corresponding configuration parameters by visiting the address of the ad page, such as “http://www.aaa.com/index.html”.

The embodiments of the disclosure also provide a browser for ad serving, which includes the ad serving plugin described above. The ad serving browser provided in the embodiments can implement the plugin embodiments described above; and the description of the plugin can be referenced for the functions achieved by the browser and will not be repeated here.

The disclosure also provides a computing device, which includes a processor; a memory unit, which stores executable code, and when the executable code is executed by the processor, it causes the processor to perform the ad serving methods described above.

The disclosure can also provide a non-transitory machine readable storage medium (or computer readable storage medium), which stores executable code (or computer programs, or computer instructions), and when the executable code (or computer programs, or computer instructions) is executed by a processor of an electronic device (or a computing device, a server, etc.), it causes the processor to perform each step according to the methods described above in the disclosure.

Those skilled in the art can understand the one or more devices involved or used in the application can be specially designed and manufactured as required, or include known devices in ordinary computers. These devices have computer programs stored therein, and the computer programs are selectively activated or refactored. The computer programs can be stored in a device (e.g., computer) readable medium or stored in any type of medium suitable for storing electronic instructions and coupled to a bus. The computer readable medium includes, but is not limited to, any type of disk (including floppy disk, hard disk, compact disk, CD-ROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card, or light card. That is, the readable medium includes any medium that can store or transmit information from the device (e.g., computer).

Those skilled in the art can understand that computer program instructions can be used to achieve each frame as well as combinations of frames in these structural diagrams and/or block diagrams and/or flow charts. Those skilled in the art can understand that these computer program instructions can be provided to general computers, dedicated computers, or any other processors for processing programmable data to be realized, thereby executing the schemes in the structural diagrams and/or block diagrams and/or flow charts frames or multiple frames disclosed in the disclosure through the computers or the any other processors for processing programmable data.

Those skilled in the art can understand that the steps, measures and schemes in each operation, method, process discussed in the disclosure can be exchanged, modified, combined or removed. Further, any other steps, measures and schemes that include the steps, measures and schemes in the each operation, method, process discussed in the disclosure can be exchanged, modified, rearranged, broken down, combined or removed. Furthermore, the steps, measures and schemes disclosed in each operation, method, process discussed in the disclosure in the current technologies can be exchanged, modified, rearranged, broken down, combined or removed.

What has been described above are some embodiments of the disclosure, and those of ordinary skills in the art can make improvements and embellishments without departing from the principles of the disclosure, and these improvements and embellishments should be considered within the scope of protection of the present disclosure.

1. A computer implementable method for ad serving, comprising:
obtaining, through a browser, a page on which an ad is to be served;
providing a serving configuration interface for serving the ad on the page;
receiving a configuration result through the serving configuration interface and determining, based on the configuration result, ad display parameters for serving the ad on the page; and
determining the page with the ad to be served based on the ad display parameters.

2. The method according to claim 1, further comprising:
loading an ad serving plugin on the browser; and
performing an initial configuration of the ad serving plugin for providing the serving configuration interface.

3. The method according to claim 1, wherein the ad display parameters comprise at least one of the following:
an ad location; an ad serving window style; an ad display color; an ad serving window size;
and an ad serving style.

4. The method according to claim 3, wherein the ad display parameters include the ad location, and receiving a configuration result through the serving configuration interface and determining, based on the configuration result, ad display parameters for serving the ad on the page comprises:
receiving a selection result of at least one adjacent element for serving the ad on the page; and
determining a position relationship of the ad to be served and the at least one adjacent element based on the selection result.

5. The method according to claim 1, further comprising:
providing a selection interface for displaying a preview result for serving the ad on the page; and
in response to receiving a preview instruction through the selection interface, displaying a preview of the page on which the ad is served.

6. The method according to claim 1, further comprising:
generating a serving configuration file based on the ad display parameters and the ad to be served; and
sending the serving configuration file to a server for the server to serve the ad on the page.

7. The method according to claim 6, further comprising:
obtaining, by the server, the ad display parameters and the ad to be served from the serving configuration file, and serving the ad on the page based on the ad display parameters.

8. The method according to claim 6, further comprising:
receiving, by a client, the page on which the ad is to be served and the serving configuration file from the server, obtaining the ad display parameters and the ad from the serving configuration file, and serving the ad on the page based on the ad display parameters.

9. A computer device comprising one or more processors and one or more non-transitory computer-readable memories coupled to the one or more processors and configured with instructions executable by the one or more processors to cause the computer device to perform operations comprising:
obtaining, through a browser, a page on which an ad is to be served;
providing a serving configuration interface for serving the ad on the page;
receiving a configuration result through the serving configuration interface and determining, based on the configuration result, ad display parameters for serving the ad on the page; and
determining the page with the ad to be served based on the ad display parameters.

10. The computer device according to claim 9, wherein the operations further comprises:
loading an ad serving plugin on the browser; and
performing an initial configuration of the ad serving plugin for providing the serving configuration interface.

11. The computer device according to claim 9, wherein the ad display parameters comprise at least one of the following:
an ad location; an ad serving window style; an ad display color; an ad serving window size;
and an ad serving style.

12. The computer device according to claim 11, wherein the ad display parameters include the ad location, and receiving a configuration result through the serving configuration interface and determining, based on the configuration result, ad display parameters for serving the ad on the page comprises:
receiving a selection result of at least one adjacent element for serving the ad on the page; and
determining a position relationship of the ad to be served and the at least one adjacent element based on the selection result.

13. The computer device according to claim 9, wherein the operations further comprises:
providing a selection interface for displaying a preview result for serving the ad on the page; and
in response to receiving a preview instruction through the selection interface, displaying a preview of the page on which the ad is served.

14. The computer device according to claim 9, wherein the operations further comprises:
generating a serving configuration file based on the ad display parameters and the ad to be served; and
sending the serving configuration file to a server for the server to serve the ad on the page.

15. A non-transitory machine-readable storage medium configured with instructions executable by one or more processors to cause the one or more processors to perform operations comprising:
obtaining, through a browser, a page on which an ad is to be served;
providing a serving configuration interface for serving the ad on the page;
receiving a configuration result through the serving configuration interface and determining, based on the configuration result, ad display parameters for serving the ad on the page; and
determining the page with the ad to be served based on the ad display parameters.

16. The non-transitory machine-readable storage medium according to claim 15, wherein the operations further comprises:
loading an ad serving plugin on the browser; and
performing an initial configuration of the ad serving plugin for providing the serving configuration interface.

17. The non-transitory machine-readable storage medium according to claim 15, wherein the ad display parameters comprise at least one of the following:
an ad location; an ad serving window style; an ad display color; an ad serving window size;
and an ad serving style.

18. The non-transitory machine-readable storage medium according to claim 17, wherein the ad display parameters include the ad location, and receiving a configuration result through the serving configuration interface and determining, based on the configuration result, ad display parameters for serving the ad on the page comprises:
receiving a selection result of at least one adjacent element for serving the ad on the page; and
determining a position relationship of the ad to be served and the at least one adjacent element based on the selection result.

19. The non-transitory machine-readable storage medium according to claim 15, wherein the operations further comprises:
providing a selection interface for displaying a preview result for serving the ad on the page; and
in response to receiving a preview instruction through the selection interface, displaying a preview of the page on which the ad is served.

20. The non-transitory machine-readable storage medium according to claim 15, wherein the operations further comprises:
generating a serving configuration file based on the ad display parameters and the ad to be served; and
sending the serving configuration file to a server for the server to serve the ad on the page.
